(19) United States
(12) Patent Application Publication
(10) Pub. No.: US 2008/0280205 A1
(43) Pub. Date: Nov. 13, 2008

(54) LITHIUM MIXED METAL OXIDE CATHODE COMPOSITIONS AND LITHIUM-ION ELECTROCHEMICAL CELLS INCORPORATING SAME

(75) Inventors: Junwei Jiang, Woodbury, MN (US); Zhonghua Lu, Woodbury, MN (US); Mark N. Obrovac, Saint Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/056,769

(22) Filed: Mar. 27, 2008

Related U.S. Application Data
(60) Provisional application No. 60/916,472, filed on May 7, 2007.
(60) Provisional application No. 61/023,447, filed on Jan. 25, 2008.

(51) Int. Cl. H01M 4/52; C01G 45/00; C01B 35/10; C01G 23/04

(52) U.S. Cl. 429/223; 423/599; 423/277; 423/598

(57) ABSTRACT

Provided are cathode compositions for a lithium-ion battery having the formula Li[LiₓMnₐNi_{b}Co_{c}M_{d}]O₂ where M is a metal other than Mn, Ni, or Co, and x+a+b+c+d=1; x≧0; b>a; 0<a≦0.4; 0.4≦b<0.5; 0.1≦c≦0.3; and 0≦d≦0.1. The provided compositions are useful as cathodes in secondary lithium-ion batteries. The compositions can include lithium transition metal oxides that can have at least two dopants from Group 2 or Group 13 elements. The transition metal oxides can include one or more materials selected from manganese, cobalt, and nickel. The provided compositions can provide cathode materials that have high specific capacities and high thermal stability.

### RELATED APPLICATIONS

This case claims priority to U.S. Provisional Patent Application No. 60/916,472, filed May 7, 2007 and 61/023,447, filed Jan. 25, 2008, both of which are herein incorporated by reference in their entirety.

### FIELD

Provided are compositions useful as cathodes for lithium-ion batteries and methods for preparing and using the same.

### BACKGROUND

Secondary lithium-ion batteries typically include an anode, an electrolyte, and a cathode that contains lithium in the form of a lithium transition metal oxide. Examples of transition metal oxides that have been used include lithium cobalt dioxide, lithium nickel dioxide, and lithium manganese dioxide. Other exemplary lithium transition metal oxide materials that have been used for cathodes include mixtures of cobalt, nickel, and/or manganese oxides.

### SUMMARY

None of these lithium transition metal oxide materials, however, exhibits an optimal combination of high initial capacity, high thermal stability, and good capacity retention after repeated charge-discharge cycling. An object of the presented cathode materials is to provide lithium-ion positive electrode compositions that are high in energy density as well as excellent in thermal stability and cycling characteristics. Another object of the presented cathode materials is to use these positive electrodes to produce lithium-ion batteries with similar characteristics.

In one aspect, provided is a cathode composition for a lithium-ion battery having the formula, Li[LiₓMnₐNi_{b}Co_{c}M¹_{d}M²ₑ]O₂, wherein M¹ and M² are different metals and are not Mn, Ni, or Co, wherein at least one of a, b, and c>0, and wherein x+a+b+c+d+e=1; −0.5≦x≦0.2; 0≦a≦0.80; 0≦b≦0.75; 0≦c≦0.88; 0≦d+e≦0.30; and at least one of d and e is >0; said composition being in the form of a single phase having a layered O3 crystal structure. The provided cathode compositions can exhibit improved electrochemical cycling performance together with capacity stability, as compared to known materials, when incorporated into a lithium-ion electrochemical cell.

In another aspect, provided is a lithium-ion electrochemical cell that includes, an anode, a cathode comprising a composition having the formula, Li[LiₓMnₐNi_{b}Co_{c}M¹_{d}M²ₑ]O₂, wherein M¹ and M² are different metals and are not Mn, Ni, or Co, wherein at least one of a, b, and c>0, and wherein x+a+b+c+d+e=1; −0.5≦x≦0.2; 0≦a≦0.80; 0≦b≦0.75; 0≦c≦0.88; 0≦d+e≦0.30; and at least one of d and e is >0; said composition being in the form of a single phase having a layered O3 crystal structure. Also provided are lithium-ion batteries that comprise at least two electrochemical cells.

In yet another aspect provided is a method of making a cathode composition that includes combining precursors of the composition having the formula, Li[LiₓMnₐNi_{b}Co_{c}M¹_{d}M²ₑ]O₂; and heating the precursors to make the composition, wherein M¹ and M² are different metals and are not Mn, Ni, or Co, wherein at least one of a, b, and c>0, and wherein x+a+b+c+d+e=1; −0.5≦x≦0.2; 0≦a≦0.80; 0≦b≦0.75; 0≦c≦0.88; 0≦d+e≦0.30; and at least one of d and e is >0; said composition being in the form of a single phase having a layered O3 crystal structure.

In this document:

the articles “a” and “an” are used interchangeably with “at least one” to mean one or more of the elements being described;

the terms “lithiate” and “lithiation” refer to a process for adding lithium to an electrode material;

the terms “delithiate” and “delithiation” refer to a process for removing lithium from an electrode material;

the terms “charge” and “charging” refer to a process for providing electrochemical energy to a cell;

the terms “discharge” and “discharging” refer to a process for removing electrochemical energy from a cell, e.g., when using the cell to perform desired work;

the phrase “positive electrode” refers to an electrode (often called a cathode) where electrochemical reduction and lithiation occurs during a discharging process; and

the phrase “negative electrode” refers to an electrode (often called an anode) where electrochemical oxidation and delithiation occurs during a discharging process.

The provided positive electrode (or cathode) compositions, and lithium-ion electrochemical cells incorporating these compositions, can exhibit a synergistic combination of high performance properties and excellent safety characteristics. High performance properties include, for example, high initial specific capacity and good specific capacity retention after repeated charge-discharge cycling. Excellent safety characteristics include properties such as not evolving substantial amount of heat at elevated temperatures, a low self-heating rate, and a high exotherm onset temperature. In some embodiments the provided compositions exhibit several, or even all, of these properties.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1a and 1b are graphs of the self-heating rate versus temperature for 3 compositions included for purposes of comparison.

FIG. 2a is a scanning electron microscopy (SEM) microphotograph of Mn_{0.33}Ni_{0.49}Co_{0.18}(OH)₂.

FIG. 2b is a scanning electron microscopy (SEM) microphotograph of Li[Li_{0.06}Mn_{0.31}Ni_{0.46}Co_{0.17}]O₂.

FIG. 3 is a graph of the potential (V) versus specific capacity (mAh/g) for three embodiments.

FIG. 4 is a graph of the specific discharge capacity (mAh/g) versus current (mA/g) for two embodiments.

FIG. 5 is a graph of the specific discharge capacity (mAh/g) versus cycle number for two coin cells that include provided cathode compositions.

FIGS. 6a and 6b are graphs of the self-heating rate versus temperature for cathode compositions.

FIG. 7 is a graph of the self-heating rate versus temperature of the compound made in Preparatory Example 1.

FIG. 8a is a graph of the self-heating rate versus temperature for two compositions made according to Preparatory Examples 3 and 4.

FIG. 8b is a graph of the self-heating rate versus temperature for two additional embodiments of the provided cathode compositions made from Preparatory Examples 5 and 6.

FIG. 9 is a graph of the specific discharge capacity (mAh/g) versus cycle number for four coin cells containing provided cathode materials.

### DETAILED DESCRIPTION

The recitation of numerical ranges includes all numbers in that range (e.g., 1 to 5 includes 1, 1.5, 2, 2.75, 3, 3.80, 4, and 5). All numbers are herein assumed to be modified by the term “about”.

In one aspect, provided is a cathode composition for a lithium-ion battery having the formula, Li[LiₓMnₐNi_{b}Co_{c}M¹_{d}M²ₑ]O₂, wherein M¹ and M² are different metals and are not Mn, Ni, or Co, wherein at least one of a, b, and c>0, and wherein x+a+b+c+d+e=1; −0.5≦x≦0.2; 0≦a≦0.80; 0≦b≦0.75; 0≦c≦0.88; 0≦d+e≦0.30; and at least one of d and e is >0; said composition being in the form of a single phase having a layered O3 crystal structure. The provided cathode compositions can exhibit improved electrochemical cycling performance together with capacity stability, as compared to known materials, when incorporated into a lithium-ion electrochemical cell. In some embodiments, the provided cathode compositions can have the formula, Li[LiₓMnₐNi_{b}Co_{c}M¹_{d}M²ₑ]O₂, wherein M¹ and M² are different metals selected from Group 2 and Group 13 elements, wherein at least one of a, b, and c>0, and wherein x+a+b+c+d+e=1; −0.5≦x≦0.2; 0≦a≦0.80; 0≦b≦0.75; 0≦c≦0.88; 0.02≦d+e≦0.30; and each of d and e is >0; said composition being in the form of a single phase having a layered O3 crystal structure. These cathode compositions can exhibit improved electrochemical cycling performance and capacity stability compared to known materials when incorporated into a lithium-ion electrochemical cell. In some embodiments, the compositions can contain from about 0.5 equivalents to about 1.2 equivalents of lithium based upon the molar amount of MnₐNi_{b}Co_{c}M¹_{d}M²ₑ in the composition. By equivalents it is meant that for every mole of MnₐNi_{b}Co_{c}M¹_{d}M²ₑ in the composition there are from about 0.5 to about 1.2 moles of lithium. In other embodiments, for every mole of MnₐNi_{b}Co_{c}M¹_{d}M²ₑ in the composition there are from about 0.9 equivalents to about 1.2 equivalents of lithium. The amount of lithium in the composition can vary depending upon the charged and discharged states of the cathode when incorporated into a lithium-ion battery. Lithium can move from and to the cathode to the anode during charging and discharging. After lithium has moved from the cathode to the anode for the first time, some of the lithium originally in the cathode material can remain in the anode. This lithium (measured as irreversible capacity) is usually not returned to the cathode and is usually not useful for further charging and discharging of the battery. During subsequent charging and discharging cycles it is possible that more lithium becomes unavailable for cycling. (Li+Liₓ) represents the molar amount lithium in the provided cathode compositions as shown in the formula above. In some states of charging of a cathode in a battery, −0.5≦x≦0.2, −0.3≦x≦0.2, −0.1≦x≦0.2, or 0≦x≦0.2.

In some embodiments, the provided cathode compositions can include transition metals selected from manganese (Mn), nickel (Ni), and cobalt (Co), and a combination thereof. The amount of Mn can range from about 0 to about 80 mole percent (mol %), greater than 20 mol % to about 80 mol %, or from about 30 mol % to about 36 mol % based upon the total mass of the cathode composition, excluding lithium and oxygen. The amount of Ni can range from about 0 to about 75 mol %, from greater than 20 mol % to about 65 mol %, or from about 46 mol % to about 52 mol % of the cathode composition, excluding lithium and oxygen. The amount of Co can range from about 0 to about 88 mol %, from greater than 20 to about 88 mol %, or from about 15 mol % to about 21 mol % of the composition, excluding lithium and oxygen.

The provided compositions can contain at least two additional materials, M¹ and M², which are hereinafter referred to as dopants. The dopants can be selected from Group 2 and Group 13 elements of the periodic table. Group 2 elements include, for example, Be, Mg, Ca, Sr, Ba, and Ra, with Mg and/or Ca preferred in some embodiments. Group 13 elements include, for example, B, Al, Ga, In, and Tl, with Al preferred in some embodiments. In some embodiments, the dopants can be selected from aluminum, boron, calcium, and magnesium. There are at least two dopants present in the provided compositions. The dopants can be present in the provided compositions such that the total amount of dopants ranges from about 2 mol % to about 30 mol % based upon the moles of LiₓMnₐNi_{b}Co_{c}M¹_{d}M²ₑ with x, a, b, c, d, and e defined as discussed above and x+a+b+c+d+e=1.

In some other embodiments, the cathode composition can contain only Ni and Co as transition metals (a=0, b>0, and c>0). In other embodiments, the composition can contain only Mn and Co as transition metals (b=0, a>0, and c>0). In yet other embodiments the composition can contain only Ni and Mn as transition metals (c=0, a>0, and b>0). At least one of Mn, Ni, and Co can be present in the provided compositions. At least two dopants, M¹ and M², can be present in the provided compositions.

The levels of d and e can vary independently. In some embodiments, at least about 0.1, at least about 0.2, at least about 1.0, at least about 2.0, at least about 3.0, at least about 5.0, at least about 10.0, or even at least 12.0 (all in mol %) of the first material (e.g., “d”) is used is used and the balance comprises the second material (e.g., “e”). The lower amount of d or e, when they are different, is ≧0, preferably at least about 0.1, 0.2, 0.5, 0.75, 1.0, 2.0, or even greater (all in mol %). The higher amount of e or d, when they are different, is <30, <25, <20, <15, <12, <10.0, <8.0, <5.5, or even lower. In other embodiments, the ratio of d to e (or vice versa) can be at least about 2, 3, 5, 10, or even greater.

In another embodiment, a cathode composition for a lithium-ion battery is provided that has the formula, Li[LiₓMnₐNi_{b}Co_{c}M¹_{d}]O₂, wherein M¹ is a metal other than Mn, Ni, or Co and x+a+b+c+d+e=1; x≧0, b>a, 0<a≦0.4, 0.4≦b<0.5, 0.1≦c≦0.3, and 0≦d≦0.1, said composition characterized as being in the form of a single phase having an O3 crystal structure. M¹ may be selected from the group consisting of Al, Ti, Mg, and combinations thereof. Specific examples of cathode compositions include those having the formulae Li[Li_{0.06}Mn_{0.31}Ni_{0.46}Co_{0.17}]O₂ and Li[Li_{0.04}Mn_{0.29}Ni_{0.48}Co_{0.19}]O₂.

X-ray diffraction (XRD) test methods can be used to show that these materials are in the form of a single phase having an O3 crystal structure.

The cathode compositions can be synthesized by any suitable method, e.g., jet milling or by combining precursors of the metal elements (e.g., hydroxides, nitrates, and the like), followed by heating to generate the cathode composition. Heating is preferably conducted in air at a maximum temperature of at least about 600° C., e.g., at least about 800° C., but preferably no greater than about 950° C. In some embodiments, the method of making the provided cathode compositions can include coprecipitation of soluble precursors of the desired composition by taking stoichiometric amount of water-soluble salts of the metals desired in the final composition (excepting lithium and oxygen) and dissolving them in an aqueous mixture. As examples, sulfate, nitrates, and halide salts can be utilized. Exemplary sulfate salts useful as precursors to the provide compositions include manganese sulfate, nickel sulfate, cobalt sulfate, aluminum sulfate, magnesium sulfate, and calcium sulfate. The aqueous mixture can then made basic (to a pH greater than about 9) by the addition of ammonium hydroxide or another suitable base as will be known by those of ordinary skill in the art. The metal hydroxides, which are not soluble at high pH, precipitate out, can be filtered, washed, and dried thoroughly to form a blend. To this blend can be added lithium carbonate, lithium hydroxide, or a combination form a mixture. In some embodiments, the mixture can be sintered by heating it to a temperature above about 750° C. and below about 950° C. for a period of time from between 1 and 10 hours. The mixture can then be heated above about 1000° C. for an additional period of time until a stable composition is formed. This method is disclosed, for example, in U.S. Pat. Publ. No. 2004/0179993 (Dahn et al.), and is known to those of ordinary skill in the art.

Alternatively, in some embodiments, the provided cathode compositions can be made by solid state synthesis as disclosed, for example, in U.S. Pat. No. 7,211,237 (Eberman et al.). Using this method, metal oxide precursors of the desired composition can be wet milled together while imparting energy to the milled ingredients to form them into a finely-divided slurry containing well-distributed metals, including lithium. Suitable metal oxides to produce provided compositions include cobalt, nickel, manganese, aluminum, boron, calcium, and magnesium oxides and hydroxides and carbonates of the same metals. Exemplary precursor materials include cobalt hydroxide (Co(OH)₂), cobalt oxides (CoO and Co₃O₄), manganese carbonate (Mn₂CO₃), manganese hydroxide (Mn(OH)₂), nickel carbonate (Ni₂CO₃), nickel hydroxide (Ni(OH)₂), magnesium hydroxide (Mg(OH)₂), magnesium carbonate (MgCO₃), magnesium oxide (MgO), aluminum hydroxide (Al(OH)₃), aluminum oxide (Al₂O₃), aluminum carbonate (Al₂CO₃), boron oxide (B₂O₃), calcium hydroxide (Ca(OH)₂), calcium oxide (CaO), and calcium carbonate (CaCO₃). Suitable lithium-containing oxides and/or oxide precursors such as lithium carbonate (Li₂CO₃) and lithium hydroxide (LiOH) can be used to introduce lithium into the cathode composition. If desired, hydrates of any of the above named precursors can be employed in this method. It is also contemplated that complex mixed metal oxides, such as those discussed in U.S. Pat. No. 5,900,385 (Dahn et al.), U.S. Pat. No. 6,660,432 (Paulsen et al.), U.S. Pat. No. 6,964,828 (Lu et al.), U.S. Pat. Publ. No. 2003/0108793 (Dahn et al.), and U.S. Ser. No. 60/916,472 (Jiang) can be used along with added additional metal oxide precursors to form the stoichiometry of the desired final cathode composition. Appropriate amounts of the precursors based upon the stoichiometry of the desired final cathode composition desired (including lithium) can be wet-milled to form a slurry. The milled slurry can be fired, baked, sintered, or otherwise heated for a sufficient time and at a sufficient temperature to form the desired single-phase compound. An exemplary heating cycle is at least 10° C./min. to a temperature of about 900° C. in an air atmosphere. More options are discussed, for example, in U.S. Pat. No. 7,211,237 (Eberman et al.).

In some embodiments, the provided cathode compositions can have high specific capacity (mAh/g) retention when incorporated into a lithium ion battery and cycled through multiple charge/discharge cycles. For example, the provided cathode compositions can have a specific capacity of greater than about 130 mAh/g, greater than about 140 mAh/g, greater than about 150 mAh/g, greater than about 160 mAh/g, greater than about 170 mAh/g, or even greater than 180 mAh/g after 50, after 75, after 90, after 100, or even more charging and discharging cycles at rates of C/2 when the battery is cycled between 2.5 and 4.3 V vs. Li and the temperature is maintained at about room temperature (25° C.).

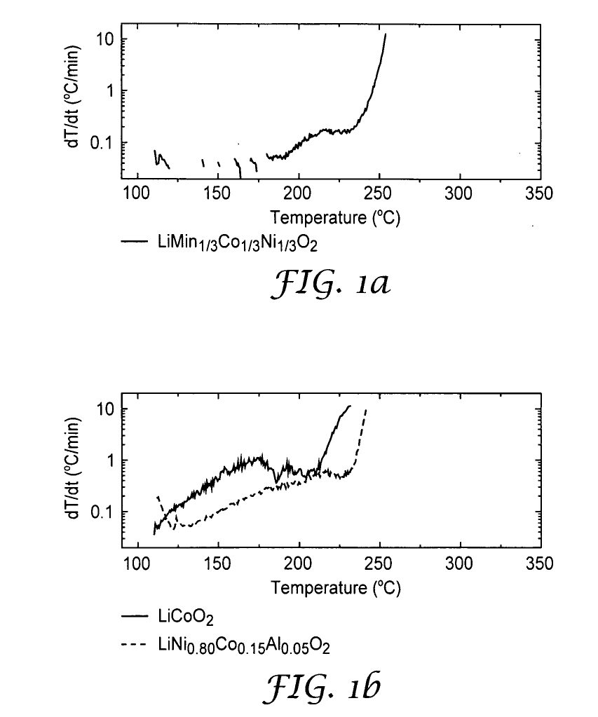

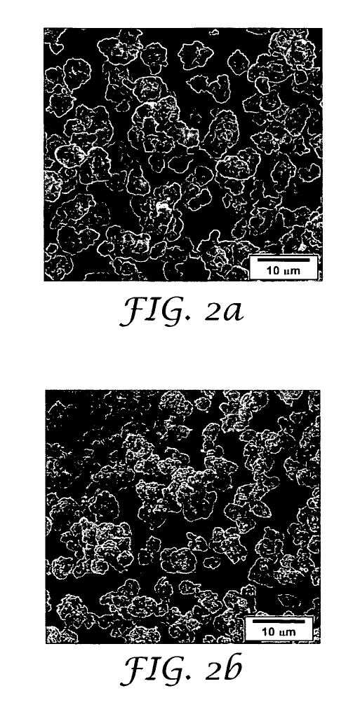

In some embodiments the provided cathode compositions can have an exotherm onset temperature of self heating in the accelerating rate calorimeter (ARC) as described in the Example section below. The ARC test is described, for example, in J. Jiang et al., Electrochemistry Communications, 6, 39-43 (2004). The provided compositions can have an exotherm onset temperature of greater than about 140° C., greater than about 150° C., greater than about 160° C., greater than about 170° C. greater than about 180° C., greater than about 190° C., or even greater than about 200° C. Provided cathode compositions can have a maximum self-heating rate that is less than about 20° C./min., less than about 15° C./min., less than about 10° C./min., or less than about 5° C./min. at temperatures below about 300° C. The self-heating rate, and thus the maximum self-heating rate, can be measured in the ARC test and can be visualized as the maximum on the graph of dT/dt vs. temperature as shown, for example, in FIGS. 1, 2A, and 2B and as explained below in the Example section.

Provided materials with at least two different dopants, selected from Group 2 and Group 13 elements, when incorporated into lithium metal oxide cathode compositions in an amount such that the total amount of all of the dopants ranges from about 2 mol % to about 30 mol % based upon the moles of LiₓMnₐNi_{b}Co_{c}M¹_{d}M²ₑ with x, a, b, c, d, and e as defined above and summed to one, can be used to make cathodes that exhibit a surprisingly synergistic combination of high specific capacity retention after cycling while also maintaining a high exotherm onset temperature and have a low maximum self-heating rate in a lithium-ion electrochemical cell or battery of electrochemical cells. Thus, high thermal stability and good capacity retention together can be achieved together with other desirable battery properties.

To make a cathode from the provided cathode compositions, the cathode composition, any selected additives such as binders, conductive diluents, fillers, adhesion promoters, thickening agents for coating viscosity modification such as carboxymethylcellulose and other additives known by those skilled in the art can be mixed in a suitable coating solvent such as water or N-methylpyrrolidinone (NMP) to form a coating dispersion or coating mixture. The coating dispersion or coating mixture can be mixed thoroughly and then applied to a foil current collector by any appropriate coating technique such as knife coating, notched bar coating, dip coating, spray coating, electrospray coating, or gravure coating. The current collectors can be typically thin foils of conductive metals such as, for example, copper, aluminum, stainless steel, or nickel foil. The slurry can be coated onto the current collector foil and then allowed to dry in air followed usually by drying in a heated oven, typically at about 80° C. to about 300° C. for about an hour to remove all of the solvent.

Cathodes made from the provided cathode compositions can include a binder. Exemplary polymer binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); aromatic, aliphatic, or cycloaliphatic polyimides, or combinations thereof. Specific examples of polymer binders include polymers or copolymers of vinylidene fluoride, tetrafluoroethylene, and propylene; and copolymers of vinylidene fluoride and hexafluoropropylene. Other binders that can be used in the cathode compositions of this disclosure include lithium polyacryate as disclosed in co-owned application, U.S. Ser. No. 11/671,601 (Le et al.). Lithium polyacrylate can be made from poly(acrylic acid) that is neutralized with lithium hydroxide. U.S. Ser. No. 11/671,601 discloses that poly(acrylic acid) includes any polymer or copolymer of acrylic acid or methacrylic acid or their derivatives where at least 50 mol %, at least 60 mol %, at least 70 mol %, at least 80 mol %, or at least 90 mol % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, hydroxyalkylacrylates, and the like.

Embodiments of the provided cathode compositions can also include an electrically conductive diluent to facilitate electron transfer from the powdered cathode composition to a current collector. Electrically conductive diluents include, but are not limited to, carbon (e.g., carbon black for negative electrodes and carbon black, flake graphite and the like for positive electrodes), metal, metal nitrides, metal carbides, metal silicides, and metal borides. Representative electrically conductive carbon diluents include carbon blacks such as SUPER P and SUPER S carbon blacks (both from MMM Carbon, Belgium), SHAWANIGAN BLACK (Chevron Chemical Co., Houston, Tex.), acetylene black, furnace black, lamp black, graphite, carbon fibers and combinations thereof.

In some embodiments, the cathode compositions can include an adhesion promoter that promotes adhesion of the cathode composition or electrically conductive diluent to the binder. The combination of an adhesion promoter and binder can help the cathode composition better accommodate volume changes that can occur in the powdered material during repeated lithiation/delithiation cycles. Binders can offer sufficiently good adhesion to metals and alloys so that addition of an adhesion promoter may not be needed. If used, an adhesion promoter can be made a part of a lithium polysulfonate fluoropolymer binder (e.g., in the form of an added functional group), such as those disclosed in U.S. Ser. No. 60/911,877 (Pham), can be a coating on the powdered material, can be added to the electrically conductive diluent, or can be a combination of such uses. Examples of adhesion promoters include silanes, titanates, and phosphonates as described in U.S. Pat. Appl. Publ. No. 2004/0058240 (Christensen).

The cathode compositions can be combined with an anode and an electrolyte to form a lithium-ion battery. Examples of suitable anodes include lithium metal, graphite, and lithium alloy compositions, e.g., of the type described in Turner, U.S. Pat. No. 6,203,944 entitled “Electrode for a Lithium Battery” and Turner, WO 00/03444 entitled “Electrode Material and Compositions.” Cathodes made from the provided cathode compositions can be combined with an anode and an electrolyte to form a lithium-ion electrochemical cell or a battery from two or more electrochemical cells. Examples of suitable anodes can be made from compositions that include lithium, carbonaceous materials, silicon alloy compositions and lithium alloy compositions. Exemplary carbonaceous materials can include synthetic graphites such as mesocarbon microbeads (MCMB) (available from E-One Moli/Energy Canada Ltd., Vancouver, BC), SLP30 (available from TimCal Ltd., Bodio Switzerland), natural graphites and hard carbons. Useful anode materials can also include alloy powders or thin films. Such alloys may include electrochemically active components such as silicon, tin, aluminum, gallium, indium, lead, bismuth, and zinc and may also comprise electrochemically inactive components such as iron, cobalt, transition metal silicides and transition metal aluminides. Useful alloy anode compositions can include alloys of tin or silicon such as Sn—Co—C alloys, Si₆₀Al₁₄Fe₈TiSn₇Mm₁₀ and Si₇₀Fe₁₀Ti₁₀C₁₀ where Mm is a Mischmetal (an alloy of rare earth elements). Metal alloy compositions used to make anodes can have a nanocrystalline or amorphous microstructure. Such alloys can be made, for example, by sputtering, ball milling, rapid quenching or other means. Useful anode materials also include metal oxides such as Li₄Ti₅O₁₂, WO₂, SiOₓ, tin oxides, or metal sulphites, such as TiS₂ and MoS₂. Other useful anode materials include tin-based amorphous anode materials such as those disclosed in U.S. Pat. Appl. No. 2005/0208378 (Mizutani et al.).

Exemplary silicon alloys that can be used to make suitable anodes can include compositions that comprise from about 65 to about 85 mol % Si, from about 5 to about 12 mol % Fe, from about 5 to about 12 mol % Ti, and from about 5 to about 12 mol % C. Additional examples of useful silicon alloys include compositions that include silicon, copper, and silver or silver alloy such as those discussed in U.S. Pat. Publ. No. 2006/0046144 A1 (Obrovac et al.); multiphase, silicon-containing electrodes such as those discussed in U.S. Pat. Publ. No. 2005/0031957 (Christensen et al.); silicon alloys that contain tin, indium and a lanthanide, actinide element or yttrium such as those described in U.S. Pat. Publ. Nos. 2007/0020521, 2007/0020522, and 2007/0020528 (all to Obrovac et al.); amorphous alloys having a high silicon content such as those discussed in U.S. Pat. Publ. No. 2007/0128517 (Christensen et al.); and other powdered materials used for negative electrodes such as those discussed in U.S. Ser. No. 11/419,564 (Krause et al.) and PCT Intl. Publ. No. WO 2007/044315 (Krause et al.). Anodes can also be made from lithium alloy compositions such as those of the type described in U.S. Pat. Nos. 6,203,944 and 6,436,578 (both to Turner et al.) and in U.S. Pat. No. 6,255,017 (Turner).

Provided electrochemical cells can contain an electrolyte. Representative electrolytes can be in the form of a solid, liquid or gel. Exemplary solid electrolytes include polymeric media such as polyethylene oxide, polytetrafluoroethylene, polyvinylidene fluoride, fluorine-containing copolymers, polyacrylonitrile, combinations thereof and other solid media that will be familiar to those skilled in the art. Examples of liquid electrolytes include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, γ-butylrolactone, methyl difluoroacetate, ethyl difluoroacetate, dimethoxyethane, diglyme (bis(2-methoxyethyl) ether), tetrahydrofuran, dioxolane, combinations thereof and other media that will be familiar to those skilled in the art. The electrolyte can be provided with a lithium electrolyte salt. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary electrolyte gels include those described in U.S. Pat. No. 6,387,570 (Nakamura et al.) and U.S. Pat. No. 6,780,544 (Noh). The charge carrying media solubilizing power can be improved through addition of a suitable cosolvent. Exemplary cosolvents include aromatic materials compatible with lithium-ion cells containing the chosen electrolyte. Representative cosolvents include toluene, sulfolane, dimethoxyethane, combinations thereof and other cosolvents that will be familiar to those skilled in the art. The electrolyte can include other additives that will familiar to those skilled in the art. For example, the electrolyte can contain a redox chemical shuttle such as those described in U.S. Pat. No. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al.), U.S. Pat. No. 6,004,698 (Richardson et al.), U.S. Pat. No. 6,045,952 (Kerr et al.), and U.S. Pat. No. 6,387,571 (Lain et al.); and in U.S. Pat. Appl. Publ. Nos. 2005/0221168, 2005/0221196, 2006/0263696, and 2006/0263697 (all to Dahn et al.).

In some embodiments, lithium-ion electrochemical cells that include provided cathode compositions can be made by taking at least one each of a positive electrode and a negative electrode as described above and placing them in an electrolyte. Typically, a microporous separator, such as CELGARD 2400 microporous material, available from Celgard LLC, Charlotte, N.C., is used to prevent the contact of the negative electrode directly with the positive electrode. This can be especially important in coin cells such as, for example, 2325 coin cells as known in the art.

Also provided is a method of making a cathode composition that includes a method of making a cathode composition that comprises combining precursors of the composition having the formula, Li[LiₓMnₐNi_{b}Co_{c}M¹_{d}M²ₑ]O₂, and heating the precursors to make the composition, wherein M¹ and M² are different metals selected from Group 2 and Group 13 elements, wherein at least one of a, b, and c>0, and wherein x+a+b+c+d+e=1; −0.5≦x≦0.2; 0≦a≦0.80; 0≦b≦0.75; 0≦c≦0.88; 0.02≦d+e≦0.30; and each of d and e is >0; said composition being in the form of a single phase having a layered O3 crystal structure.

The disclosed electrochemical cells can be used in a variety of devices, including portable computers, tablet displays, personal digital assistants, mobile telephones, motorized devices (e.g., personal or household appliances and vehicles), instruments, illumination devices (e.g., flashlights) and heating devices. One or more electrochemical cells of this invention can be combined to provide battery pack. Further details as to the construction and use of the provided lithium-ion cells and battery packs are familiar to those skilled in the art.

Objects and advantages of this invention are further illustrated by the following examples, but the particular materials and amounts thereof recited in these examples, as well as other conditions and details, should not be construed to unduly limit this invention.

### EXAMPLES

### Electrochemical Cell Preparation

### Thin Film Cathode Electrodes for Electrochemical Tests

Electrodes were prepared as follows. A 10 wt % polyvinylidene difluoride (PVDF, Aldrich Chemical Co.) in N-methyl pyrrolidinone (NMP, Aldrich Chemical Co.) solution was prepared by dissolving 10 g PVDF into 90 g of NMP. 7.33 g SUPER P carbon (MMM Carbon, Belgium), 73.33 g of 10 wt % PVDF in NMP solution, and 200 g NMP were mixed in a glass jar. The mixed solution contains about 2.6 wt % of PVDF and SUPER P carbon, each in NMP. 5.25 g of this solution was mixed with 2.5 g cathode material by Mazerustar mixer machine (Kurabo Industries Ltd., Japan) for 3 minutes to form a uniform slurry. The slurry was then spread onto a thin aluminum foil supported on a glass plate using a 0.25 mm (0.010 inch) notch-bar spreader. The coated electrode was then dried in an oven set at 80° C. for around 30 minutes. The electrode was then put into an oven set at 120° C. vacuum oven for 1 hour. The electrode coating contains about 90 wt % cathode material and 5 wt % PVDF and SUPER P each. The mass loading of the active cathode material was around 8 mg/cm².

### Cell Construction for Thin Film Electrodes.

The coin cells were fabricated with the resulting cathode electrode and Li metal anode in a 2325-size (23 mm diameter and 2.5 mm thickness) coin-cell hardware in a dry room. The separator was a CELGARD No. 2400 microporous polypropylene film (Celgard, LLC, Charlotte, N.C.), which had been wetted with a 1M solution of LiPF₆ (Stella Chemifa Corporation, Japan) dissolved in a 1:2 volume mixture of ethylene carbonate (EC) (Aldrich Chemical Co.) and diethyl carbonate (DEC) (Aldrich Chemical Co.).

### Accelerating Rate Calorimeter (ARC)

ARC was used to test the exothermic activity between the charged electrodes and the electrolyte. The important parameters for comparing the exothermic activity of different cathode compositions was evaluated by determining the exotherm onset temperature of the sample and the maximum self-heating rate of the sample during the ARC test. Pellet electrodes were prepared for the ARC thermal stability tests.

### Preparation of Pellet Electrodes for ARC.

The method to prepare charged cathode materials for thermal stability tests by ARC was described in J. Jiang, et al., Electrochemistry Communications, 6, 39-43, (2004). Usually, the mass of a pellet electrode used for the ARC is a few hundred milligrams. A few grams of active electrode material were mixed with 7 wt % each of SUPER P carbon black, PVDF, and excess NMP to make a slurry, following the same procedures described in A.1. After drying the electrode slurry at 120° C. overnight, the electrode powder was slightly ground in a mortar and then passed through a 300 μm sieve. A measured amount of electrode powder was then placed in a stainless steel die to which 13.8 MPa (2000 psi) was applied to produce an approximately 1-mm thick pellet electrode. A 2325-size coin cell was constructed using the positive electrode pellet and the Mesocarbon microbeads (MCMB) (E-One Moli/Energy Canada Ltd., Vancouver, BC) pellet that was used as the anode was sized to balance the capacity of both electrodes. The cells were charged to a desired voltage, such as 4.4 V vs. Li, at a current of 1.0 mA. After reaching 4.4 V, the cells were allowed to relax to 4.1 V vs. Li. Then the cells were recharged to 4.4 V using half of the original current, 0.5 mA. After 4 additional charging and discharging cycles, with the current reduced by one-half at each successive cycle, the charged cells were transferred to the glove box and dissembled. The charged cathode pellets were taken out and rinsed four times with dimethyl carbonate (DMC) in argon-filled glove box. Then the sample was dried in the glove box antechamber for two hours to remove the residual DMC. Finally the sample was lightly ground again to be used in the ARC tests.

### ARC Exotherm Onset Temperature Measurement

The stability test by ARC was described in J. Jiang, et al., Electrochemistry Communications, 6, 39-43, (2004). The sample holder was made from 304 stainless steel seamless tubing with a wall thickness of 0.015 mm (0.006 in.) (Microgroup, Medway, Mass.). The outer diameter of the tubing was 6.35 mm (0.250 in.) and the length of pieces cut for the ARC sample holders was 39.1 mm (1.540 in.). The temperature of the ARC was set to 110° C. to start the test. The sample was equilibrated for 15 min., and the self-heating rate was measured over a period of 10 min. If the self-heating rate was less than 0.04° C./min., the sample temperature was increased by 10° C., at a heating rate of 5° C./min. The sample was equilibrated at this new temperature for 15 min., and the self-heating rate was again measured. The ARC Exotherm Onset Temperature was recorded when the self-heating rate was sustained above 0.04° C./min. The test was stopped when the sample temperature reached 350° C. or the self-heating rate exceeded 20° C./min.

ARC Exotherm Onset Temperature with Delithiated LiCoO2, Delithiated LiNi_{0.08}Co_{0.15}Al_{0.05}O₂, and Delithiated LiMn_{1/3}Co_{1/3}Ni_{1/3}O₂ with Electrolytes

LiCoO₂ (average particle diameter approximately 5 μm) was obtained from E-One Moli/Energy Canada Ltd. (Vancouver, BC). LiNi_{0.80}Co_{0.15}Al_{0.05}O₂ (average particle size around 6 μm) was from Toda Kongo Corp. (Japan). LiMn_{1/3}Co_{1/3}Ni_{1/3}O₂ (BC-618, average particle size 10 μm) was produced by 3M Company. The thermal stability tests of delithiated LiCoO₂, LiNi_{0.80}Co_{0.15}Al_{0.05}O₂, and LiMn_{1/3}Co_{1/3}Ni_{1/3}O₂ in LiPF₆ EC/DEC (1:2 by volume) were conducted and the thermal stability comparison data are displayed in FIGS. 1a and 1b and Table 1. LiCoO₂, LiNi_{0.80}Co_{0.15}Al_{0.05}O₂, and LiMn_{1/3}Co_{1/3}Ni_{1/3}O₂ cathode materials were charged to 4.4 V, 4.2 V, and 4.4 V, respectively, since they delivered similar amounts of reversible capacity (approximately 180 mAh/g) at such voltages. The ARC exotherm onset temperatures of charged LiCoO₂ (4.4 V), LiNi_{0.80}Co_{0.15}Al_{0.05}O₂ (4.2 V), and LiMn_{1/3}Co_{1/3}Ni_{1/3}O₂ (4.4 V) with LiPF₆ in EC/DEC are 110° C., 110° C., and 180° C., respectively, as shown in FIGS. 1a-1b. This suggests that there is no significant exothermic reaction between LiMn_{1/3}Ni_{1/3}Co_{1/3}O₂ (4.4 V) and LiPF₆ in EC/DEC electrolyte until 180° C. and that LiMn_{1/3}Co_{1/3}Ni_{1/3}O₂ (4.4 V) has a greater thermal stability than both LiCoO₂ (4.4 V) and LiNi_{0.80}Co_{0.15}Al_{0.05}O₂ (4.2 V) materials.

### ARC Maximum Self-Heating Rate Measurement

The maximum self-heating rate was the maximum heating rate, dT/dt, that the sample reached during the ARC test. It was determined by examining the ARC data graph of dT/dt and recording the highest or maximum self-heating rate observed during the ARC testing. The maximum self-heating rate represents the speed of temperature increase of the ARC sample, which due to thermal reaction of the sample. Higher maximum self-heating rates indicate materials that are less thermally stable than those with lower maximum self-heating rates.

### Preparatory Example 1

### Synthesis of Li[Li_{0.06}Mn_{0.31}Ni_{0.46}Co_{0.17}]O₂

129.32 g of NiSO₄.6H₂O (Aldrich Chemical Co.), 55.44 g of MnSO₄.H₂O (Aldrich Chemical Co.), and 50.60 g of CoSO₄.H₂O (Aldrich Chemical Co.) were dissolved in distilled water within a 500 ml volumetric flask to form a 2 mol/L transition metal sulfate solution. Mn_{0.33}Ni_{0.49}Co_{0.18}(OH)₂ was prepared by a co-precipitation method from the transition metal sulfate solution with NaOH solution at a PH value around 10. The precipitate was recovered by filtration and washed repeatedly using vacuum filtration. It was then placed in a box furnace set to 120° C. to dry. After grinding, 8.00 g of precipitate powder (containing around 3% moisture) was mixed with 3.536 g of Li₂CO₃. The mixture powder was heated to 750° C. at a rate of 4° C./min and then soaked at that temperature for 4 hours. The mixture powder then was heated to 850° C. at 4° C./min and soaked for 4 hours. After that, the powder was cooled to room temperature at 4° C./min. After grinding, the powder was passed through a 110-μm sieve.

### Preparatory Example 2

### Synthesis of Li[Li_{0.04}Mn_{0.29}Ni_{0.48}Co_{0.19}]O₂

Li[Li_{0.04}Mn_{0.29}Ni_{0.48}Co_{0.19}]O₂ was prepared using the procedure in Preparatory Example 1, adjusting the reagents accordingly. SEM picture of Mn_{0.33}Ni_{0.49}Co_{0.18}(OH)₂ and Li[Li_{0.06}Mn_{0.31}Ni_{0.46}Co_{0.17}]O₂ sintered are shown in FIG. 2a and FIG. 2b, respectively. The average particle size of Mn_{0.33}Ni_{0.49}Co_{0.18}(OH)₂ and Li[Li_{0.06}Mn_{0.31}Ni_{0.46}Co_{0.17}]O₂ was approximately 6 μm.

### Preparatory Example 3

### Li[Mn_{0.29}Ni_{0.43}Co_{0.16}Al_{0.12}]O₂

Li[Mn_{0.29}Ni_{0.43}Co_{0.16}Al_{0.12}]O₂ was prepared using the procedure of Preparatory Example 1 but adjusting the reagents accordingly.

### Preparatory Example 4

### Li[Mn_{0.29}Ni_{0.43}Co_{0.16}Mg_{0.12}]O₂

Li[Mn_{0.29}Ni_{0.43}Co_{0.16}Mg_{0.12}]O₂ was prepared using the procedure of Comparative Preparatory Example 1 but adjusting the reagents accordingly.

### Preparatory Example 5

### Li[Mn_{0.29}Ni_{0.43}Co_{0.16}Al_{0.06}Mg_{0.06}]O₂

Li[Mn_{0.29}Ni_{0.43}Co_{0.16}Al_{0.06}Mg_{0.06}]O₂ was prepared using the procedure of Comparative Preparatory Example 1 but adjusting the reagents accordingly.

### Preparatory Example 6

### Li[Mn_{0.31}Ni_{0.46}Co_{0.17}Al_{0.03}Mg_{0.03}]O₂

Li[Mn_{0.31}Ni_{0.46}Co_{0.17}Al_{0.03}Mg_{0.03}]O₂ was prepared using the procedure of Comparative Preparatory Example 1 but adjusting the reagents accordingly.

### Performance

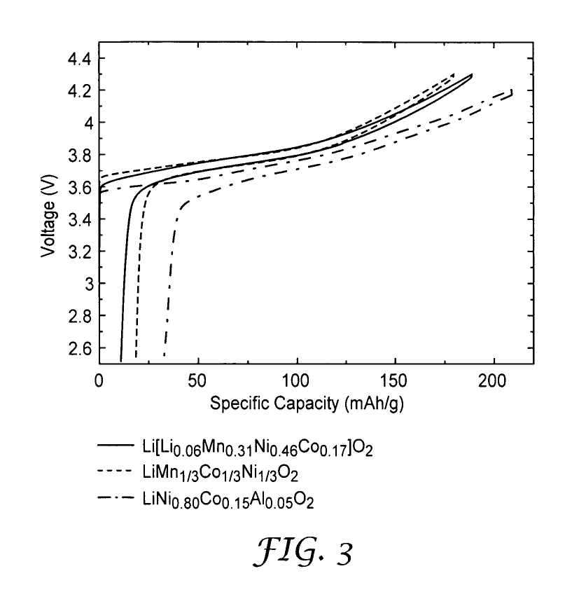

FIG. 3 shows the comparison of potential (V) versus specific capacity (mAh/g) for Li[Li_{0.06}Mn_{0.31}Ni_{0.46}Co_{0.17}]O₂, LiMn_{1/3}Co_{1/3}Ni_{1/3}O₂, and LiNi_{0.80}Co_{0.15}Al_{0.05}O₂ materials. It was clearly shown that Li[Li_{0.06}Mn_{0.31}Ni_{0.46}Co_{0.17}]O₂ delivered a high discharge capacity up to 178 mAh/g. The average discharge voltage of Li[Li_{0.06}Mn_{0.31}Ni_{0.46}Co_{0.17}]O₂ was close to that of LiMn_{1/3}Co_{1/3}Ni_{1/3}O₂, which is around 0.16 V higher than the average voltage of the LiNi_{0.80}Co_{0.15}Al_{0.05}O₂ material.

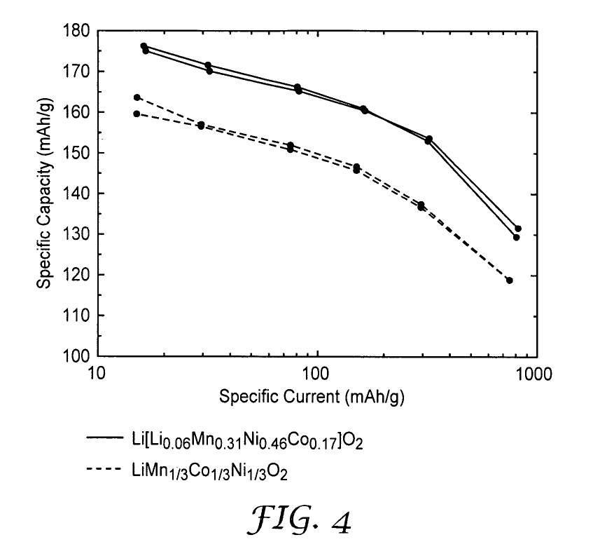

FIG. 4 shows the rate comparison between Li[Li_{0.06}Mn_{0.31}Ni_{0.46}Co_{0.17}]O₂ and LiMn_{1/3}Co_{1/3}Ni_{1/3}O₂ from 2.5 to 4.3 V vs. Li metal. Li[Li_{0.06}Mn_{0.31}Ni_{0.46}Co_{0.17}]O₂ delivered a discharge capacity of about 155 mAh/g at a current of 300 mA/g, compared with 136 mAh/g of LiMn_{1/3}Co_{1/3}Ni_{1/3}O₂.

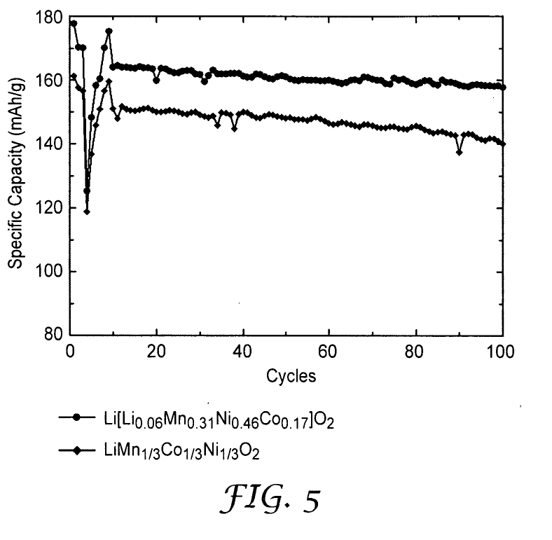

FIG. 5 shows the cycling performance comparison between Li[Li_{0.06}Mn_{0.31}Ni_{0.46}Co_{0.17}]O₂ and LiMn_{1/3}Co_{1/3}Ni_{1/3}O₂ from 2.5 to 4.3 V. Li[Li_{0.06}Mn_{0.31}Ni_{0.46}Co_{0.17}]O₂ clearly showed higher capacity and better capacity retention after 100 cycles at a current of 75 mAh/g than LiMn_{1/3}Co_{1/3}Ni_{1/3}O₂.

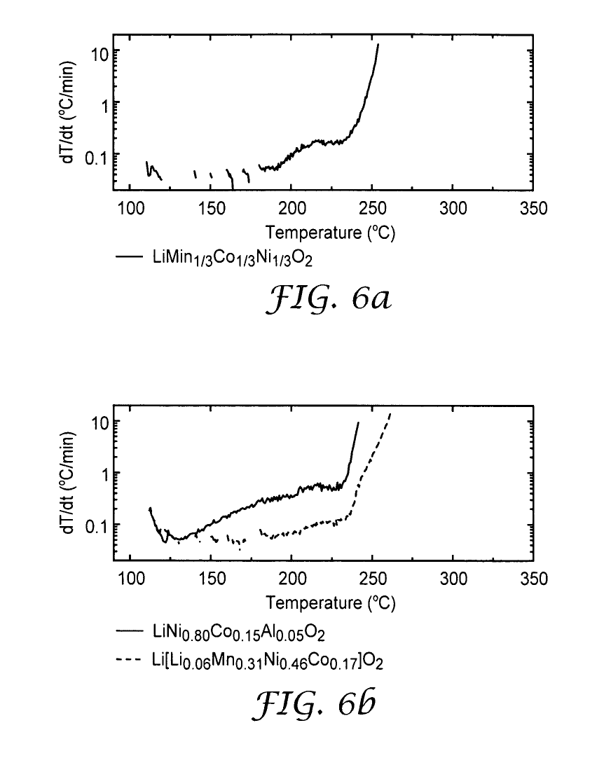

FIG. 6a shows self-heating rate versus temperature of 100 mg of Li[Li_{0.06}Mn_{0.31}Ni_{0.46}Co_{0.17}]O₂ charged to 4.4 V vs. Li metal reacting with 30 mg of 1M LiPF₆ EC/DEC electrolyte by ARC. The ARC curves for charged LiMn_{1/3}Co_{1/3}Ni_{1/3}O₂, and LiNi_{0.80}Co_{0.15}Al_{0.05}O₂ were added into FIG. 6b for comparison. Li[Li_{0.06}Mn_{0.31}Ni_{0.46}Co_{0.17}]O₂ (4.4 V) has an ARC exotherm onset temperature of 180° C., which is similar to that of LiMn_{1/3}Co_{1/3}Ni_{1/3}O₂ (4.4 V). This suggests that Li[Li_{0.06}Mn_{0.31}Ni_{0.46}Co_{0.17}]O₂ has similar thermal stability to that of LiMn_{1/3}Co_{1/3}Ni_{1/3}O₂.

Table 2 summarizes the performance comparison of Li[Li_{0.06}Mn_{0.31}Ni_{0.46}Co_{0.17}]O₂, LiMn_{1/3}Co_{1/3}Ni_{1/3}O₂ and LiNi_{0.80}Co_{0.15}Al_{0.05}O₂ in discharge capacity, average voltage, and ARC exotherm onset temperatures. Li[Li_{0.06}Mn_{0.31}Ni_{0.46}Co_{0.17}]O₂ has high specific discharge capacity (178 mAh/g) from 2.5 to 4.3 V, high average discharge voltage (3.78 V), and excellent thermal stability (180° C. of ARC exotherm onset temperature).

TABLE 1
Comparison of ARC exotherm onset temperatures of LiCoO₂
(4.4 V vs. Li), LiNi_{0.80}Co_{0.15}Al_{0.05}O₂ (4.2 V),
and LiMn_{1/3}Co_{1/3}Ni_{1/3}O₂ (4.4 V) in LiPF₆ EC/DEC.

| | | ARC |
|---|---|---|
| | Charge Voltage | Exotherm Onset |
| Materials | (V vs. Li) | Temperatures |
| LiCoO₂ | 4.4 | 110° C. |
| LiNi_{0.80}Co_{0.15}Al_{0.05}O₂ | 4.2 | 110° C. |
| LiMn_{1/3}Co_{1/3}Ni_{1/3}O₂ | 4.4 | 180° C. |

TABLE 2
Comparison of Li[Li_{0.06}Mn_{0.31}Ni_{0.46}Co_{0.17}]O₂,
LiNi_{0.80}Co_{0.15}Al_{0.05}O₂, LiMn_{1/3}Co_{1/3}Ni_{1/3}O₂ in
specific discharge capacity, average discharge voltage,
rate capability, and ARC exotherm onset temperature.

| | | | ARC |
|---|---|---|---|
| | | | Exotherm |
| | Specific | Average | Onset |
| | Discharge | Discharge | Temper- |
| Materials | Capacity | Voltage | atures |
| Li[Li_{0.06}Mn_{0.31}Ni_{0.46}Co_{0.17}]O₂ | 178 mAh/g | 3.78 V | 180° C. |
| | (2.5 to 4.3 V) | | |
| LiNi_{0.80}Co_{0.15}Al_{0.05}O₂ | 179 mAh/g | 3.62 V | 110° C. |
| | (2.5 to 4.2 V) | | |
| LiMn_{1/3}Co_{1/3}Ni_{1/3}O₂ | 155 mAh/g | 3.80 V | 180° C. |
| | (2.5 to 4.3 V) | | |

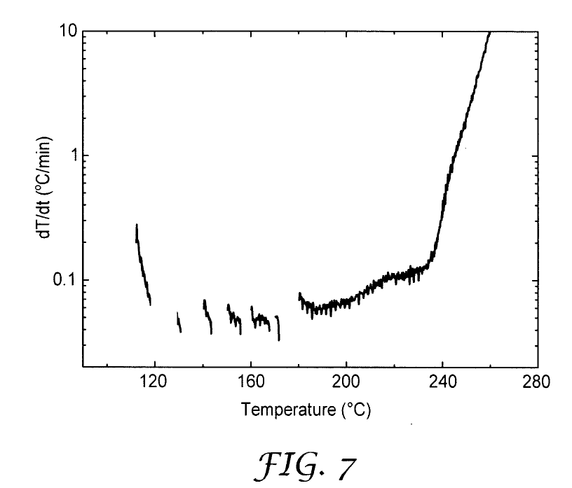

FIG. 7 shows the self-heating rate (° C./min) versus temperature of 100 mg charged Li[Li_{0.06}Mn_{0.31}Ni_{0.46}Co_{0.17}]O₂ (4.4V vs. Li metal), reacting with around 30 mg of 1M LiPF₆ EC/DEC (1:2 by volume). The charged material showed good thermal stability in the ARC test and the exotherm onset temperature was measured to be around 180° C. The exothermic reaction between charged Li[Li_{0.06}Mn_{0.31}Ni_{0.46}Co_{0.17}]O₂ and electrolyte started to rise quickly at around 240° C. and later went to thermal runaway at around 260° C. (maximum self-heating rate higher than 20° C./min.).

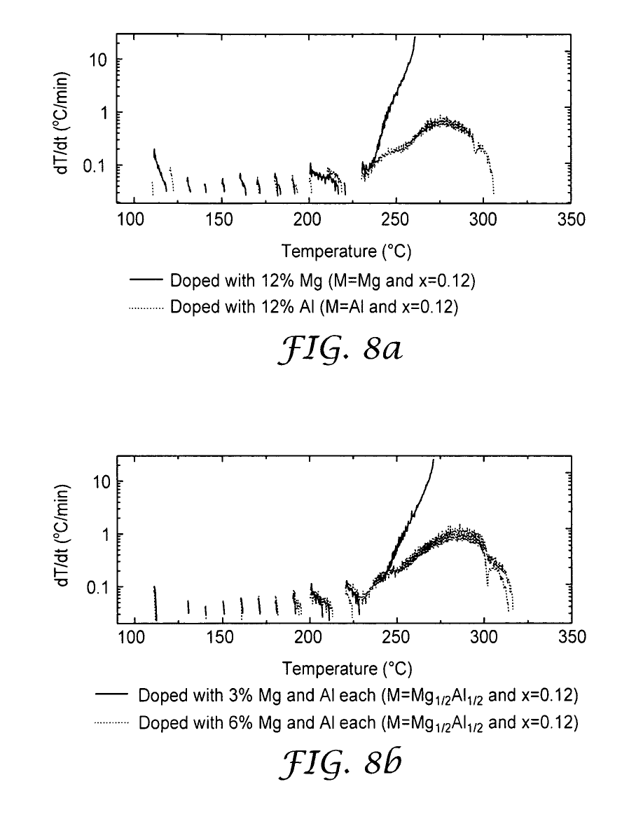

FIG. 8a shows the self-heating rate (° C./min) versus temperature of two charged cathode materials that are comparative examples, Li[Mn_{0.29}Ni_{0.43}Co_{0.16}Mg_{0.12}]O₂ (12 mol % Mg dopant) and Li[Mn_{0.29}Ni_{0.43}Co_{0.16}Al_{0.12}]O₂ (12 mol % Al dopants), that reacted with 1M LiPF₆ EC/DEC (1:2 by volume). The figure shows that both charged materials had a high exotherm onset temperature around 230° C. The self-heating rate of charged Li[Mn_{0.29}Ni_{0.43}Co_{0.16}Mg_{0.12}]O₂ increased quickly and went to thermal runaway at around 260° C. However, the charged Li[Mn_{0.29}Ni_{0.43}Co_{0.16}Al_{0.12}]O₂ material showed a significant lower self-heating rate than charged Li[Mn_{0.29}Ni_{0.43}Co_{0.16}Mg_{0.12}]O₂ and the maximum self-heating rate was only around 0.8° C./min. This data suggests that Li[Mn_{0.29}Ni_{0.43}Co_{0.16}Al_{0.12}]O₂ has much higher thermal stability than Li[Mn_{0.29}Ni_{0.43}Co_{0.16}Mg_{0.12}]O₂.

FIG. 8b shows the ARC test results one embodiment of the provided cathode compositions. Li[Mn_{0.29}Ni_{0.43}Co_{0.16}Al_{0.06}Mg_{0.06}]O₂ showed a maximum self-heating rate around 1.0° C./min.

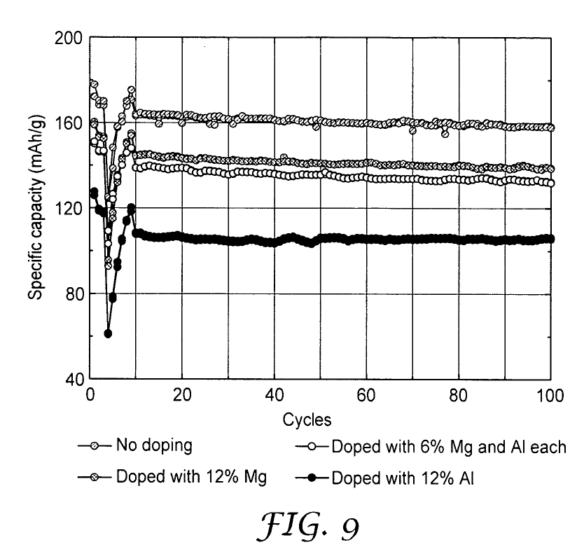

FIG. 9 shows the cycling performance comparison of cathode compositions, Li[Mn_{0.29}Ni_{0.43}Co_{0.16}Mg_{0.12}]O₂, Li[Mn_{0.29}Ni_{0.43}Co_{0.16}Al_{0.12}]O₂, Li[Mn_{0.31}Ni_{0.46}Co_{0.17}Al_{0.03}Mg_{0.03}]O₂ and Li[Mn_{0.29}Ni_{0.43}Co_{0.16}Al_{0.06}Mg_{0.06}]O₂. Undoped material, Li[Li_{0.06}Mn_{0.31}Ni_{0.46}Co_{0.17}]O₂, was measured to have a capacity of around 164 mAh/g from 2.5 V to 4.3 V at C/2 rate. All the other doped cathode materials showed lower discharge capacity since the dopants (Al and Mg) are not electrochemically active. Li[Mn_{0.29}Ni_{0.43}Co_{0.16}Al_{0.12}]O₂ (12% Al dopant) was measured to have the lowest discharge capacity of around 107 mAh/g and both Li[Mn_{0.29}Ni_{0.43}Co_{0.16}Al_{0.06}Mg_{0.06}]O₂ (6% Al and Mg dopant each) and Li[Mn_{0.29}Ni_{0.43}Co_{0.16}Mg_{0.12}]O₂ (12% Mg dopant) showed similar capacity around 140 mAh/g at C/2 rate.

It is clear from the ARC tests that aluminum dopant increases the maximum self-heating temperature and the exotherm onset temperature of the lithium mixed metal oxide cathode materials but decreases specific capacity. The use of a mixture of aluminum and magnesium dopant makes up for some of the capacity loss of aluminum alone while maintaining the thermal stability of the mixture. Li[Mn_{0.29}Ni_{0.43}Co_{0.16}Al_{0.06}Mg_{0.06}]O₂ is to have a synergistic combination of properties of high thermal stability and high discharge capacity.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All documents and references cited within this application are herein incorporated by reference in their entirety.

What is claimed is:

1. A cathode composition for a lithium-ion battery having the formula,
Li[LiₓMnₐNi_{b}Co_{c}M¹_{d}M²ₑ]O₂,
wherein M¹ and M² are different metals and are not Mn, Ni, or Co, wherein at least one of a, b, and c>0, and
wherein x+a+b+c+d+e=1; −0.5≦x≦0.2; 0≦a≦0.80; 0≦b≦0.75; 0≦c≦0.88; 0≦d+e≦0.30; and at least one of d and e is >0; said composition being in the form of a single phase having a layered O3 crystal structure.

2. A cathode composition for a lithium-ion battery according to claim 1, wherein M¹ and M² are selected from Group 2 and Group 13 elements, 0.02≦d+e≦0.30; and each of d and e is >0; said composition being in the form of a single phase having a layered O3 crystal structure.

3. The composition according to claim 2, wherein −0.1≦x≦0.2.

4. The composition according to claim 2, wherein 0.20<a≦0.80, 0.20<b≦0.65, and 0.20<c≦0.88.

5. The composition according to claim 2, wherein a=0, b>0, and c>0.

6. The composition according to claim 2, wherein b=0, a>0, and c>0.

7. The composition according to claim 2, wherein c=0, a>0, and b>0.

8. The composition according to claim 2, wherein M¹ and M² are selected from aluminum, boron, calcium, magnesium, and combinations thereof.

9. The composition according to claim 8, wherein M¹ and M² are aluminum and magnesium.

10. The composition according to claim 2, wherein after 90 charge/recharge cycles, the specific capacity at 25° C. is greater than about 130 mAh/g, when electrodes made with the composition are incorporated into a lithium-ion battery and cycled at a C/2 rate between from about 2.5 to about 4.3 V vs. Li.

11. The composition according to claim 2, wherein the exotherm onset temperature of self-heating in the ARC test is greater than about 170° C.

12. The composition according to claim 11, wherein the exotherm onset temperature in the ARC test in greater than about 200° C.

13. The composition according to claim 2, wherein the maximum self-heating rate is less than about 20° C./min.

14. A cathode composition for a lithium-ion battery according to claim 1, wherein x≧0; b>a; 0<a≦0.4; 0.4≦b<0.5; 0.1≦c≦0.3; 0≦d≦0.1 and e=0, and wherein said composition is characterized as being in the form of a single phase having an O3 crystal structure.

15. A cathode composition according to claim 14, wherein M¹ is selected from the group consisting of Al, Ti, Mg, and combinations thereof.

16. A cathode composition according to claim 14, having the formula
Li[Li_{0.06}Mn_{0.31}Ni_{0.46}Co_{0.17}]O₂ or Li[Li_{0.04}Mn_{0.29}Ni_{0.48}Co_{0.19}]O₂.

17. A lithium-ion electrochemical cell comprising:
an anode;
a cathode; and
an electrolyte separating said anode and said cathode,
wherein the cathode comprises a composition having the formula,
Li[LiₓMnₐNi_{b}Co_{c}M¹_{d}M²ₑ]O₂,
wherein M¹ and M² are different metals and are not Mn, Ni, or Co, wherein at least one of a, b, and c>0, and
wherein x+a+b+c+d+e=1; −0.5≦x≦0.2; 0≦a≦0.80; 0≦b≦0.75; 0≦c≦0.88; 0≦d+e≦0.30; and at least one of d and e is >0; said composition being in the form of a single phase having a layered O3 crystal structure.

18. An electronic device comprising an electrochemical cell according to claim 17.

19. The device according to claim 18, wherein the device is selected from portable computers, personal or household appliances, vehicles, instruments, illumination devices, flashlights, and heating devices.

20. A method of making a cathode composition comprising:
combining precursors of the composition having the formula,
Li[LiₓMnₐNi_{b}Co_{c}M¹_{d}M²ₑ]O₂; and
heating the precursors to make the composition,
wherein M¹ and M² are different metals and are not Mn, Ni, or Co, wherein at least one of a, b, and c>0, and
wherein x+a+b+c+d+e=1; −0.5≦x≦0.2; 0≦a≦0.80; 0≦b≦0.75; 0≦c≦0.88; 0≦d+e≦0.30; and at least one of d and e is >0; said composition being in the form of a single phase having a layered O3 crystal structure.
